(19) United States
(12) Patent Application Publication
(10) Pub. No.: US 2025/0277603 A1
(43) Pub. Date: Sep. 4, 2025

(54) DUAL-COOL CRYO-ADAPTER

(71) Applicant: Raytheon Company, Tewksbury, MA (US)

(72) Inventors: Dana K. McCoy, Tucson, AZ (US); James Lawrence Denker, Tucson, AZ (US); Marianne D. Goble, Tucson, AZ (US)

(21) Appl. No.: 18/595,260

(22) Filed: Mar. 4, 2024

(51) Int. Cl. F25B 9/02; F41G 7/22; G01J 5/061

(52) U.S. Cl. CPC F25B 9/02; G01J 5/061; F41G 7/22

(57) ABSTRACT

A seeker includes a housing, a digital focal plane array (DFPA), and a cryo-adapter. The DFPA is positioned in the housing. The cryo-adapter is positioned in the housing adjacent to the DFPA. The cryo-adapter is configured to remove heat from the DFPA. The cryo-adapter includes an end cap and tubing. The endcap forms an interior for the cryo-adapter, and the tubing is configured to supply liquefied cryogen to the interior of the cryo-adapter.

### TECHNICAL FIELD

This disclosure relates generally to cryogenic cooling devices and processes. More specifically, this disclosure relates to a dual-cool cryo-adapter.

### BACKGROUND

There are an increasing number of devices that, for proper operation, require cooling to very low temperatures. For example, certain infrared detectors used in heat seeking missile guidance systems often require cryogenic cooling.

### SUMMARY

This disclosure relates to a dual-cool cryo-adapter.

In a first embodiment, a seeker includes a housing, a digital focal plane array (DFPA), and a cryo-adapter. The DFPA is positioned in the housing. The cryo-adapter is positioned in the housing adjacent to the DFPA. The cryo-adapter is configured to remove heat from the DFPA. The cryo-adapter includes an end cap and tubing. The endcap forms an interior for the cryo-adapter, and the tubing is configured to supply liquefied cryogen to the interior of the cryo-adapter.

In a second embodiment, a dual-cool cryo-adapter includes an end cap and tubing. The endcap forms an interior for the cryo-adapter. The tubing is configured to supply liquefied cryogen to the interior of the cryo-adapter.

In a third embodiment, a method includes removing heat through an endcap forming an interior of a cryo-adapter. The method also includes supplying liquefied cryogen to the interior of the cryo-adapter through tubing.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example seeker with a dual-cool cryo-adapter in accordance with this disclosure;

FIG. 2 illustrates an example dual-cool cryo-adapter in accordance with this disclosure;

FIG. 3 illustrates an example interior of a dual-cool cryo-adapter in accordance with this disclosure; and

FIG. 4 illustrates an example heat transfer diagram for dual-cool cryo-adapter according to this disclosure.

### DETAILED DESCRIPTION

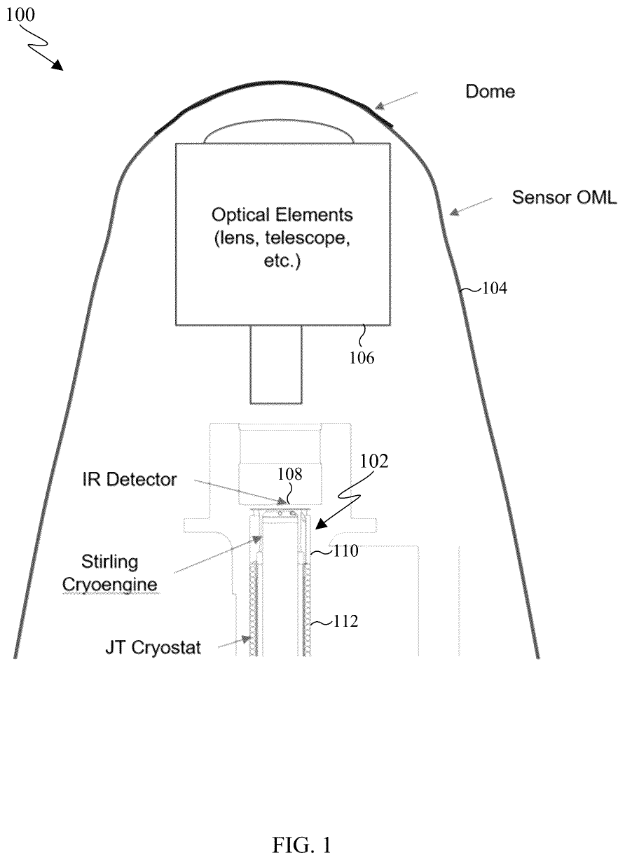

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, there are an increasing number of devices that, for proper operation, require cooling to very low temperatures. For example, certain infrared detectors used in heat seeking missile guidance systems often require cryogenic cooling. While adequate external coolant is generally available on a missile launcher or launch platform to cool an infrared detector and maintain its operation in a standby mode prior to launch, cooling systems on a seeker need improvement. In the past where such cryogenic cooling was needed onboard a seeker, for instance, the cooling could only be satisfied by the use of a cryo-system, which added an excessive amount of start-up time. This disclosure provides dual-cool cryo-adapters that are (among other things) able to provide cryogenic cooling for airborne vehicles, such as missiles, which can provide cooling for launch readiness through the use of an internal liquefied coolant and which can maintain the cooling with a very small solid cryogenic adapter placed next to the infrared detector.

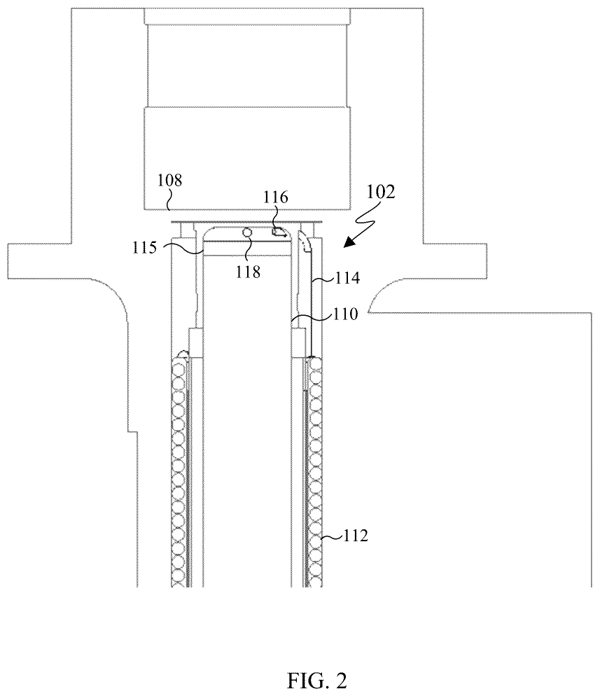

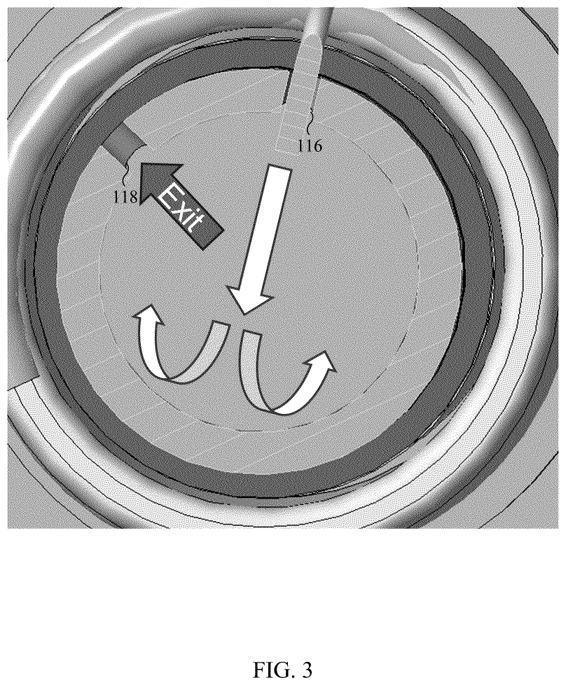

FIG. 1 illustrates an example seeker 100 with a dual-cool cryo-adapter 102 in accordance with this disclosure. FIG. 2 illustrates an example dual-cool cryo-adapter 102 in accordance with this disclosure. FIG. 3 illustrates an interior of a dual-cool cryo-adapter 102 in accordance with this disclosure. As shown in FIGS. 1 through 3, a seeker 100 includes a dual-cool cryo-adapter 102, a housing 104, optical elements 106, and an infrared (IR) detector 108. The housing 104 may house, support, or protect the dual-cool cryo-adapter 102, the optical elements 106, and the IR detector 108.

The optical elements 106 can be positioned in a nose of the housing 104. The optical elements 106 can include one or more lenses, telescope, etc. The optical elements 106 can receive reflected infrared radiation from a target, filter the received radiation, and focus the received radiation to the IR detector 108. Specifically, the optical elements 106 redirect incident light such that the energy converges on a selected portion of the IR detector 108. The optical elements 106 can ensure that the received light is properly focused on the IR detector 108, and thus facilitates the detection of reflected infrared source.

The IR detector 108 detects the presence of the light that has passed through the optical elements 106 and generates a signal which is communicated to a guidance system. In general, the guidance system receives the signal communicated from the IR detector 108 and provides signals to the flight control system to control the path of the projectile. As such, the guidance system may include moving components, such as a gimbaled seeker, or may be fixed-post. The guidance system may further comprise any additional elements or components to facilitate implementation, such as a housing, connectors, retaining rings, alignment rings, barrels, pins, adhesives, gaskets, compliant material, spacers, and/or the like.

The IR detector 108 may be configured in any appropriate manner to detect the relevant energy and generate corresponding signals. In particular, the IR detector 108 may be configured to produce an output signal in response to incident light. The output signal may vary depending on the position of the incident radiation on the IR detector 108, and may vary in response to a change in the properties of incident radiation, such as pulse frequency, energy density, wavelength, and total energy. The IR detector 108 may comprise any appropriate energy detection system, such as a digital imaging system comprising an active pixel sensor, single-pixel light detectors, photocells, charge-coupled devices, and the like. In certain examples the IR detector 108 is a digital focal plane array (DFPA) sensor that includes a two-dimensional array of light-sensitive pixels. In some examples the IR detector 108 is sensitive to IR radiation and may convert incident IR radiation into electrical signals that may be analyzed by a processor to detect and track targets, for example. The IR detector 108 may be sensitive to IR radiation within a selected portion of the IR spectrum.

Signals generated by the IR detector 108 may be analyzed to determine the direction from which light is received, such as to guide the projectile to a target. For example, the IR detector 108 may generate signals corresponding to the amount of energy striking different parts of the IR detector 108. In particular, in certain examples the IR detector 108 may convert incident light into electrical signals indicative of an angular bearing to a designated target. For example, IR detector 108 may be a quad-cell detector that provides four electrical signals indicative of the amount of light incident on each of four quadrants of the detector. The bearing to the designated target may then be determined from the relative strength of each of the four signals.

The dual-cool cryo-adapter 102 can remove heat or cool the IR detector 108 in order for the IR detector 108 remain below ambient temperature to reduce thermal noise. The dual-cool cryo-adapter 102 includes a Stirling cryo-engine 110, a Joule-Thomson cryostat 112, tubing 114, and an endcap 115. The endcap 115 can be positioned near the IR detector 108 and can draw heat from around the IR detector 108. The endcap 115 can be made of a material with a high thermal transfer coefficient, such as a metal like copper.

The operation principle of Stirling cryo-engine 110 relates to the rising and falling of a compression piston and a displacer in accordance with a refrigeration cycle. A Stirling cryo-engine 110 includes a compressor having a compression piston, a regenerator having a regenerating agent, a displacer forming an expansion chamber and a compression chamber, a cooling part formed between the expansion chamber and the regenerator, and a heat rejection part formed around the compression chamber. A working gas is sealed under high pressure in a hermetically sealed flow passage constituted by these members, and the compression piston, of the compressor, and the displacer are reciprocated with a phase difference therebetween. The Stirling cryo-engine 110 can use a thermal paste interface to enhance heat transfer.

A Joule-Thomson cryostat 112 can be used to transfer heat from the dual-cool cryo-adapter 102. The Joule-Thomson cryostat 112 includes a generally cylindrical body member, with a helical winding of hollow finned heat exchanger tubing 114 arranged thereabout and enclosed at its inner end by an endcap 115. Liquified cryogen from a tubing nozzle 116, located at the end of tubing 114, is sprayed into the cryo-cell through the endcap 115 when the Joule-Thomson cryostat 112 is operative.

The tubing 114 can be coiled about the outside of the dual-cool cryo-adapter 102. Conventional use of the tubing is to spray liquified cryogen on an outside surface of an adapter. However, only a portion of the cooling effect from the liquified cryogen is utilized by spraying the liquified cryogen on the outside of the adapter. The tubing 114 of the dual-cool cryo-adapter 102 includes a tubing nozzle 116 that extends through the endcap 115 into an interior of the dual-cool cryo-adapter 102. Providing the liquefied cryogen into the dual-cool cryo-adapter 102 allows for greater heat transfer from between the liquefied cryogen and the dual-cool cryo-adapter 102.

The dual-cool cryo-adapter 102 further includes an exit port 118 in the endcap 115 for the liquified cryogen to leave the dual-cool cryo-adapter 102. This allows for continuous application of charged liquefied cryogen to be applied to the dual-cool cryo-adapter 102. In certain embodiments, the exit port 118 can be provided to disperse the liquefied cryogen along an outside surface of the dual-cool cryo-adapter 102 for additional heat transfer.

Although FIGS. 1 through 3 illustrate an example seeker 100 with a dual-cool cryo-adapter 102, various changes may be made to FIGS. 1 through 3. For example, various components in FIGS. 1 through 3 may be combined, further subdivided, replicated, omitted, or rearranged and additional components may be added according to particular needs.

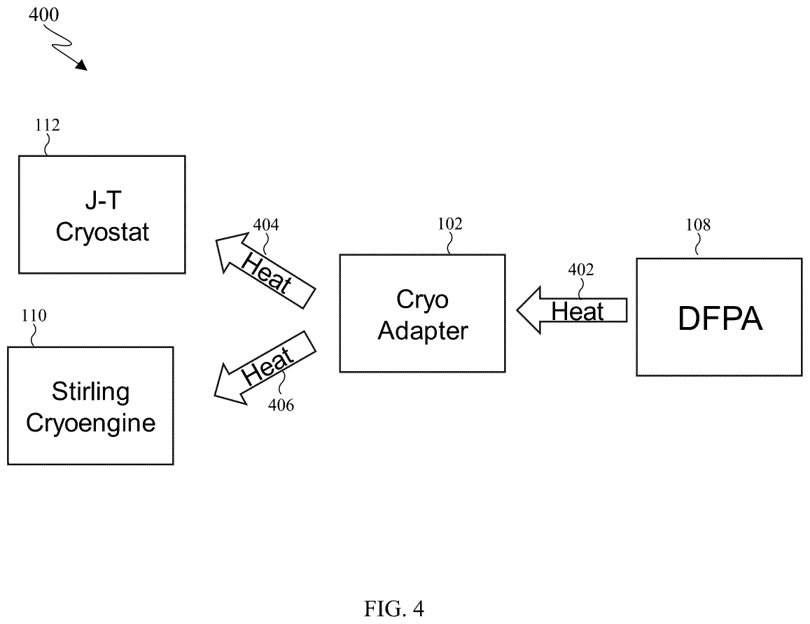

FIG. 4 illustrates an example heat transfer diagram 400 for a dual-cool cryo-adapter 102 according to this disclosure. As shown in FIG. 4, heat is transferred from the DFPA to the dual-cool cryo-adapter 102 at heat transfer 402. The DFPA can refer to the IR detector 108. The DFPA can be positioned in the housing 104 adjacent to the dual-cool cryo-adapter 102. Removing heat using the dual-cool cryo-adapter 102 can reduce thermal noise in the readings of the DFPA, which positively impacts the performance of the DFPA. The heat can be transferred through an endcap 115 of the dual-cool cryo-adapter 102. Tubing 114 extending around an outside surface of the dual-cool cryo-adapter 102 is used to supply liquefied cryogen through the endcap 115 into the interior of the dual-cool cryo-adapter 102.

Heat is transferred from the dual-cool cryo-adapter 102 to the Joule-Thomson cryostat 112 at heat transfer 404. The liquefied cryogen sprayed into the interior of the dual-cool cryo-adapter 102 is used as a heat transfer medium for the Joule-Thomson cryostat 112.

Heat is transferred from the dual-cool cryo-adapter 102 to the Stirling cryo-engine 110 at heat transfer 406. The liquefied cryogen sprayed into the interior of the dual-cool cryo-adapter 102 is used as a heat transfer medium for the Stirling cryo-engine 110. The same liquefied cryogen is used for both the Stirling cryo-engine 110 and Joule-Thomson cryostat 112.

Although FIG. 4 illustrates one example of an example heat transfer diagram 400 for a dual-cool cryo-adapter 102, various changes may be made to FIG. 4. For example, while shown as a series of steps, various steps in FIG. 4 may overlap, occur in parallel, or occur any number of times.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A seeker comprising:
a housing;
a digital focal plane array (DFPA) positioned in the housing; and
a cryo-adapter positioned in the housing adjacent to the DFPA and configured to remove heat from the DFPA, the cryo-adapter comprising:
an end cap forming an interior for the cryo-adapter; and
tubing configured to supply liquefied cryogen to the interior of the cryo-adapter.

2. The seeker of claim 1, wherein the tubing comprises a nozzle that extends into the interior of the cryo-adapter and that is configured to disperse the liquefied cryogen.

3. The seeker of claim 1, wherein the cryo-adapter further comprises an exit port configured to release the liquefied cryogen from the interior of the cryo-adapter.

4. The seeker of claim 3, wherein the exit port is configured to disperse the liquefied cryogen along an outside surface of the cryo-adapter.

5. The seeker of claim 1, wherein the cryo-adapter further comprises a Joule-Thomson cryostat configured to transfer heat from the cryo-adapter.

6. The seeker of claim 5, wherein the cryo-adapter further comprises a Sterling cryo-engine configured to transfer heat from the cryo-adapter.

7. The seeker of claim 6, wherein the liquefied cryogen dispersed in the interior of the cryo-adapter is used as a heat transfer medium for both of the Joule-Thomson cryostat and the Sterling cryo-engine.

8. A cryo-adapter comprising:
an end cap forming an interior for the cryo-adapter; and
tubing configured to supply liquefied cryogen to the interior of the cryo-adapter.

9. The cryo-adapter of claim 8, wherein the tubing comprises a nozzle that extends into the interior of the cryo-adapter and that is configured to disperse the liquefied cryogen.

10. The cryo-adapter of claim 8, wherein the cryo-adapter further comprises an exit port configured to release the liquefied cryogen from the interior of the cryo-adapter.

11. The cryo-adapter of claim 10, wherein the exit port is configured to disperse the liquefied cryogen along an outside surface of the cryo-adapter.

12. The cryo-adapter of claim 8, wherein the cryo-adapter further comprises a Joule-Thomson cryostat configured to transfer heat from the cryo-adapter.

13. The cryo-adapter of claim 12, wherein the cryo-adapter further comprises a Sterling cryo-engine configured to transfer heat from the cryo-adapter.

14. The cryo-adapter of claim 13, wherein the liquefied cryogen dispersed in the interior of the cryo-adapter is used as a heat transfer medium for both of the Joule-Thomson cryostat and the Sterling cryo-engine.

15. A method comprising:
removing heat through an endcap forming an interior of a cryo-adapter; and
supplying liquefied cryogen to the interior of the cryo-adapter through tubing.

16. The method of claim 15, further comprising:
dispersing, using a nozzle that extends into the interior of the cryo-adapter, the liquefied cryogen.

17. The method of claim 15, further comprising:
releasing, using an exit port, the liquefied cryogen from the interior of the cryo-adapter.

18. The method of claim 17, further comprising:
dispersing, using the exit port, the liquefied cryogen along an outside surface of the cryo-adapter.

19. The method of claim 15, further comprising:
transferring, using a Joule-Thomson cryostat, heat from the cryo-adapter; and
transferring, using a Sterling cryo-engine, heat from the cryo-adapter.

20. The method of claim 19, wherein the liquefied cryogen dispersed in the interior of the cryo-adapter is used as a heat transfer medium for both of the Joule-Thomson cryostat and the Sterling cryo-engine.
